(19) United States
(12) Patent Application Publication
(10) Pub. No.: US 2018/0233917 A1
(43) Pub. Date: Aug. 16, 2018

(54) SYSTEM AND METHOD FOR INVERTER OPERATION WITH MULTIPLE DC FEEDS

(71) Applicant: EATON CORPORATION, Cleveland, OH (US)

(72) Inventors: Armen Baronian, Toronto (CA); Prasanna Sharadchandra Nirantare, Pune (IN)

(73) Assignee: EATON CORPORATION, Cleveland, OH (US)

(21) Appl. No.: 15/434,250

(22) Filed: Feb. 16, 2017

(51) Int. Cl. H02J 3/38; H02M 7/44; H02M 1/36

(52) U.S. Cl. CPC H02J 3/383; H02M 1/36; H02M 7/44

(57) ABSTRACT

A method of starting a power system including an inverter having a plurality of DC feeds, wherein the DC feeds include a first DC feed and a number of additional DC feeds. The method includes connecting the first DC feed to a DC link of the inverter, synchronizing the inverter to an AC grid, and connecting the synchronized inverter to the AC grid. The method also includes, for each of the additional DC feeds, responsive to determining: (i) that a predetermined time period based on a required power ramp rate of the inverter has elapsed, and (ii) that current operating conditions of the inverter are within a safe operating area of a plurality of switching devices of the inverter, connecting the additional DC feed to the DC link.

### BACKGROUND

### Field

The disclosed concept pertains generally to power systems, such as photovoltaic (PV) power systems or other renewable energy systems, and, more particularly, to power system such as a PV system, that includes an inverter configured to operate using multiple direct current (DC) feeds that employs a methodology for switching the DC feeds on in a manner that ensures that the inverter stays within the safe operating area (SOA) of the switching devices of the inverter.

### Background Information

A photovoltaic (PV) system is a power system that converts sunlight into electricity. In a PV system, an array of solar panels, known as a PV array, converts solar radiation directly into DC electricity. A PV inverter is used to couple the PV array to an AC network, such as an AC power grid, by converting the DC power into AC power. The PV industry is rapidly moving towards 1500 VDC systems because such systems provide a number of benefits, including lower losses and lower per watt system costs. As is known in the art, many different topologies, such as two-level and three level topologies, may be used to implement a PV inverter. Using a two level topology to implement a 1500 VDC PV system can be problematic because commercially available switching devices, such as insulated-gate bipolar transistors (IGBTs), that support high power (e.g., 1500 VDC) operation have limitations. In particular, in a 1500 VDC PV system, the PV inverter would start operation at the open circuit voltage (Voc) at zero power. The power would then be ramped up at a steep slope to maximum power (Pmp) at Vmp (which is the voltage at Pmp). In such a system, the switching devices, such as IGBTs, would have to support large powers at voltages close to 1500 VDC. Problems will arise if the inverter operates outside of the SOA of the switching devices while it ramps to Pmp.

### SUMMARY

In one embodiment, a method of starting a power system including an inverter having a plurality of DC feeds is provided, wherein the DC feeds include a first DC feed and a number of additional DC feeds. The method includes connecting the first DC feed to a DC link of the inverter, synchronizing the inverter to an AC grid, and connecting the synchronized inverter to the AC grid. The method also includes, for each of the additional DC feeds, responsive to determining: (i) that a predetermined time period based on a required power ramp rate of the inverter has elapsed, and (ii) that current operating conditions of the inverter are within a safe operating area of a plurality of switching devices of the inverter, connecting the additional DC feed to the DC link.

In another embodiment, power system is provided that includes an inverter having a plurality of DC feeds, the DC feeds including a first DC feed and a number of additional DC feeds, a DC link, and a plurality of switching devices. The controller is structured and configured to connect the first DC feed to the DC link, synchronize the inverter to an AC grid (24), connect the synchronized inverter to the AC grid, and for each of the additional DC feeds, responsive to determining: (i) that a predetermined time period based on a required power ramp rate of the inverter has elapsed, and (ii) that current operating conditions of the inverter are within a safe operating area of the plurality of switching devices, connect the additional DC feed to the DC link.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a 1500 VDC PV system according to an exemplary embodiment of the disclosed concept;

FIGS. 2 and 3 are a flowchart showing a method of operating the PV system of FIG. 1, and in particular, a method of starting up the inverter thereof, according to one non-limiting exemplary embodiment of the disclosed concept;

FIGS. 4 and 5 are alternative computer algorithms for performing an IGBT SOA check according exemplary embodiment of the disclosed concept; and

FIGS. 6-8 are graphs showing the results of a simulation of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As used herein, the term “number” shall mean one or an integer greater than one (i.e., a plurality).

As used herein, the statement that two or more parts are “coupled” together shall mean that the parts are joined together either directly or joined through one or more intermediate parts.

As used herein, the term “safe operating area (SOA)” shall mean the voltage and current conditions over which a power semiconductor device, such as, without limitation, an IGBT, can be expected to operate without self-damage.

As used herein, the term “controller” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

The disclosed concept provides a high power PV system solution that includes a multiple DC feed architecture wherein each DC feed is connected to the inverter DC link through a DC contactor. As described in more detail herein, each DC feed contactor is closed with a time delay that is based on logic that ensures that the inverter operation stays within the SOA of the inverter switching devices and that also ensures that the required power ramp rate is satisfied.

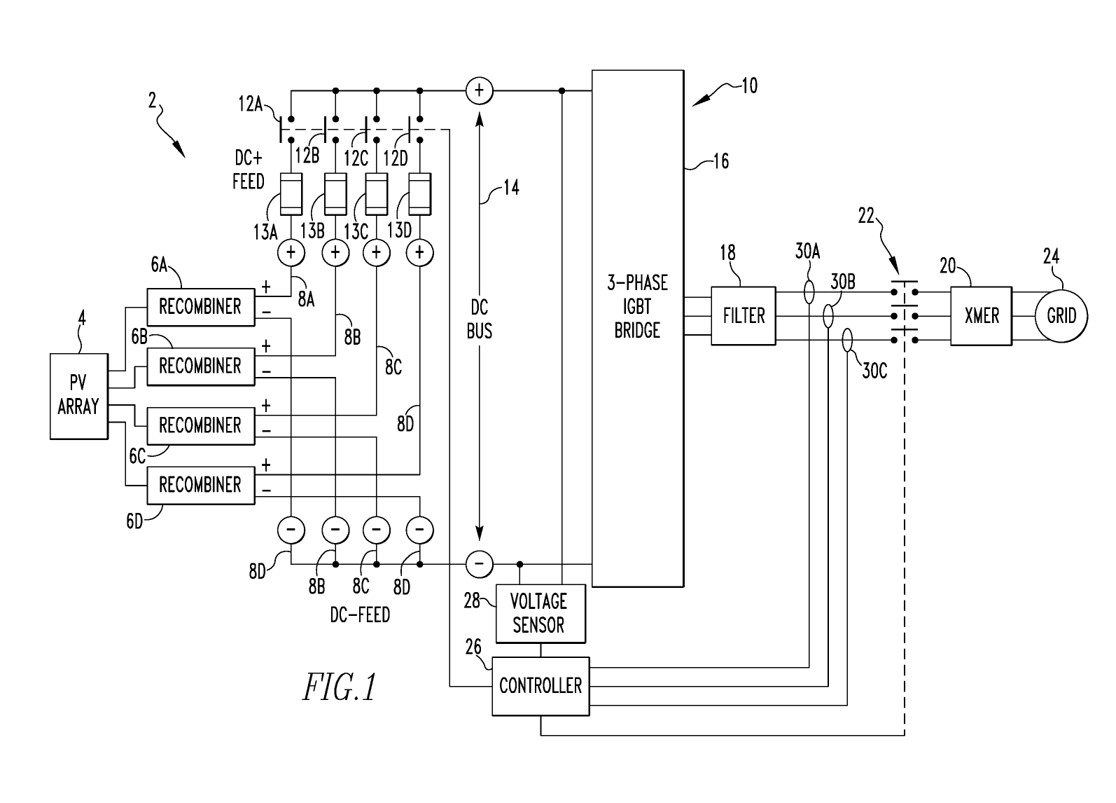

FIG. 1 is a schematic diagram of a 1500 VDC PV system 2 according to an exemplary embodiment of the disclosed concept. PV system 2 includes a PV array 4 which, as is known in the art, includes a plurality of PV modules connected in series in panels, also known as strings, to enhance the DC voltage. In large PV systems, multiple strings are typically combined together in parallel in a device known as a combiner to multiply the string output currents to higher levels for input into the PV inverter. Furthermore, in large PV systems, multiple combiners are often necessary, and the outputs of these combiners may need to be combined again, i.e., recombined, before reaching the PV inverter. The device that performs the recombining operation is known a recombiner.

Thus, in the non-limiting, exemplary embodiment of the disclosed concept, the strings of PV array 4 are first coupled to a plurality of combiners (not shown), and the combiner outputs are then coupled to a plurality of recombiners 6 before reaching a central inverter 10 (described below) forming part of PV system 2. In the non-limiting, exemplary embodiment, PV system 2 includes four such recombiners 6, labeled 6A-6D. Each recombiner 6 is associated with an individual DC feed 8 of PV system 2. The DC feeds 8 (each having a + feed portion and a − feed portion as shown) are the inputs to inverter 10. Thus, in the illustrated exemplary embodiment, PV system 2 includes eight such DC feeds 8, labeled 8A-8D. Each DC feed 8A-8D is coupled to inverter 10 through an associated DC contactor 12, labeled 12A-12D, and fuse 13, labeled 13A-13D. It will be appreciated, however, that this particular configuration is meant to be exemplary only and that more or less than four recombiners 6 and four DC feeds 8 may be employed within the scope of the disclosed concept.

Inverter 10 includes a DC link or bus 14, a 3-phase IGBT bridge 16, which in the non-limiting, exemplary embodiment is a two-level topology, a filter 18, and an isolation transformer 20. A 3-phase AC contactor 22 is provided in between filter 18 and isolation transformer 20. The output of isolation transformer 20 is connected to AC grid 24.

PV system 2 further includes a controller 26 that is structured and configured to control the operation of PV system 2 as described in detail herein. As seen in FIG. 1, PV system 2 also includes a voltage sensor 28 coupled to DC link 14 for measuring the DC voltage of DC link 14. The output of voltage sensor 28 is provided to controller 26. PV system 2 further includes current sensors 30A, 30B and 30C (e.g., Rogowski coils) that are coupled to the three phase output of 3-phase IGBT bridge 16 after filter 28. Current sensors 30A, 30B and 30C are structured to measure the current of each phase output of 3-phase IGBT bridge 16. The outputs of current sensors 30A, 30B and 30C are provided to controller 26. PV system 2 may further includes voltage sensors in place of or in addition to current sensors 30A, 30B and 30C for measuring and providing to controller 26 the AC voltage of each phase output of 3-phase IGBT bridge 16.

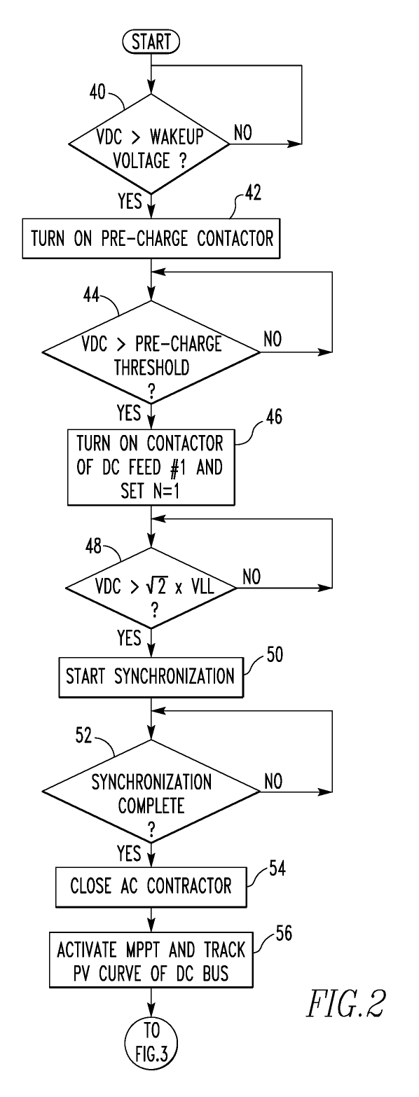

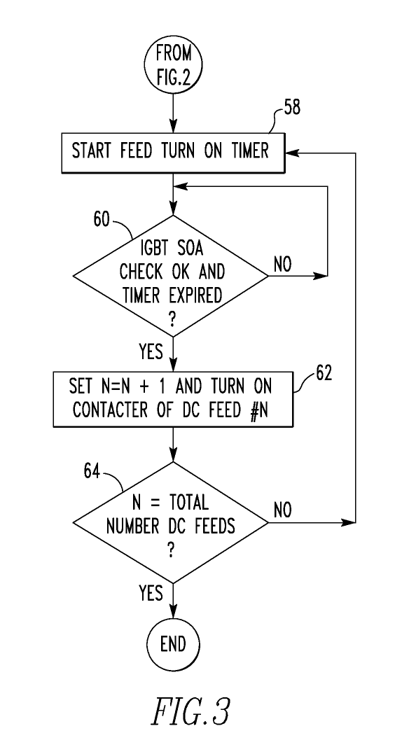

FIGS. 2 and 3 are a flowchart showing a method of operating PV system 2, and in particular, a method of starting-up inverter 10, according to one non-limiting exemplary embodiment of the disclosed concept. The method shown in FIGS. 2 and 3 is, in the exemplary embodiment, implemented in controller 26 via a number of firmware routines stored in the memory portion of controller 26 and executable by the processing portion of controller 26. As described in more detail below, in the disclosed method, the DC feeds 8A-8D are fed into inverter 10 sequentially. During each feed-in, controller 26 ensures that the IGBT SOA of inverter 10 is not violated as the power is increased. Also during each feed-in, controller 26 ensures that the required power ramp rate is satisfied. In the exemplary embodiment shown in FIG. 1 and used to describe the disclosed method below, DC feed 8A is designated DC feed #1, DC feed 8B is designated DC feed #2, DC feed 8C is designated DC feed #3, and DC feed 8D is designated DC feed #4. Again, it will be appreciated that this is meant to be exemplary only and that other configurations are contemplated within the scope of the disclosed concept.

Referring first to FIG. 2, the method begins at step 40, wherein the DC voltage (VDC) on DC link 14 is measured and a determination is made as to whether VDC is greater than a predetermined, stored wakeup voltage. If the answer is no, then the method returns to step 40 to continue to monitor VDC. If the answer at step 40 is yes, then the method proceeds to step 42. At step 42, a precharge contactor (not shown) forming part of PV system 2 is turned on by controller 26. As is known in the art, typically, before an inverter, such as inverter 10, is connected to a PV array, such as PV array 4, the DC bus capacitors of the inverter are charged in a controlled manner through a precharge contactor and a resistor to avoid capacitor current surge. After the DC capacitors charge to a required threshold, the resistor charging path is cut out by opening the precharge contactor and the PV array is connected to the DC bus capacitors. Thus, in the exemplary embodiment, at step 44, a determination is made as to whether VDC is greater than a predetermined, stored precharge threshold level. If the answer is no, then the method returns to step 44 to continue to monitor the precharge status of inverter 10. If the answer at step 44 is yes, then the method proceeds to step 46.

At step 46, controller 26 turns on (i.e., closes) DC contactor 12A of DC feed 8A (which, as noted above, in this example is designated DC feed #1), and a variable N (which indicates the number of DC feeds that are actually connected to inverter 10 at any time) is set to 1. Next, at step 48, a determination is made as to whether VDC is greater than √2*VLL. VLL is the line to line voltage amplitude of the grid voltage of grid 24. In the exemplary embodiment, VDC being greater than √2*VLL is the condition that is required in order for the two level inverter topology of exemplary inverter 10 to operate normally. If the answer at step 48 is no, then the method returns to step 48 to continue to monitor VDC as compared to √2*VLL. If the answer at step 48 is yes, then the method proceeds to step 50. At step 50, controller 26 starts a grid synchronization process. In particular, as is known in the art, the grid voltage of grid 24 may be characterized by the amplitude, frequency and phase angle thereof. Inverter 10 is said to be synchronized to grid 24 if the output voltage of inverter 10 matches grid 24 in amplitude, frequency and phase angle, at which point inverter 10 may be connected to grid 24. In the exemplary embodiment, the grid voltage is sensed and a phase locked loop (PLL) is used to determine the voltage, frequency and phase of grid 24. Controller 26 then generates gate pulses for 3-phase IGBT bridge 16 so that the voltage generated by inverter 10 matches the grid voltage, frequency and phase from the PLL. Thus, at step 52, a determination is made as to whether the synchronization process is complete. If the answer is no, then the method returns to step 52 to continue to monitor the status of the synchronization process. If the answer at step 52 is yes, then inverter 10 may be connected to grid 24 and controller 26 closes AC contactor 22 to do so. Then, at step 56, controller 26 activates a maximum power point tracking (MPPT) algorithm implemented in controller 26 to track the PV curve of DC link 14. As is well known in the art, MPPT is a technique used commonly with wind turbines and PV systems to maximize power extraction under all conditions. In the exemplary embodiment, MPPT would maximize power extraction by monitoring and adjusting the load characteristic of PV system 2 to keep the power transfer from PV array 4 at its highest efficiency. Following step 56, the method proceeds to step 58 (FIG. 3).

Referring to FIG. 3, at step 58, a “feed turn on” timer is started by controller 26. The duration of the feed turn on timer is determined based on the pre-set power ramp rate of PV system 2. Next, at step 60, a determination is made as to whether two separate conditions are being satisfied. The first condition is whether an IGBT SOA check performed by controller 26 is “OK”, meaning that controller 26 has determined that the operating conditions of inverter 10 are within the SOA of the IGBTs of 3-phase IGBT bridge 16. This check may be performed in a number of ways. Two non-limiting exemplary algorithms for performing such a check are described herein. The second condition of step 60 is whether the feed turn on timer has expired. If the answer at step 60 is no, then the method proceeds to step 60 to continue to monitor the two conditions.

If the answer as step 60 is yes, meaning that IGBT SOA check is OK and that the feed turn on timer has expired, then the method proceeds to step 62. At step 62, the variable N, described above, is set equal to N+1 and the DC contactor 12 of DC feed #N is turned on (i.e., closed). As stated above, in the illustrated exemplary embodiment, DC feed 8B is DC feed #2, DC feed 8C is DC feed #3 and DC feed 8D is DC feed #4. Then, at step 64, a determination is made as to whether the variable N is equal to the total number of DC feeds 8 that are present in PV system 2. In the illustrated exemplary embodiment, the total number of DC feeds present in PV system 2 is four. If the answer at 64 is no (meaning that all of the DC feeds have not yet been turned on and fed-in), then the method returns to step 58. If the answer at 64 is yes (meaning that all of the DC feeds have been turned on and fed-in), then startup of inverter 10 is complete.

Thus, the method just described results in all of the DC feeds 8A-8D of PV system 2 being fed into inverter 10 sequentially, wherein during each feed-in, controller 26 ensures that (i) IGBT SOA is not violated as the power is increased, and (ii) the required power ramp rate is satisfied.

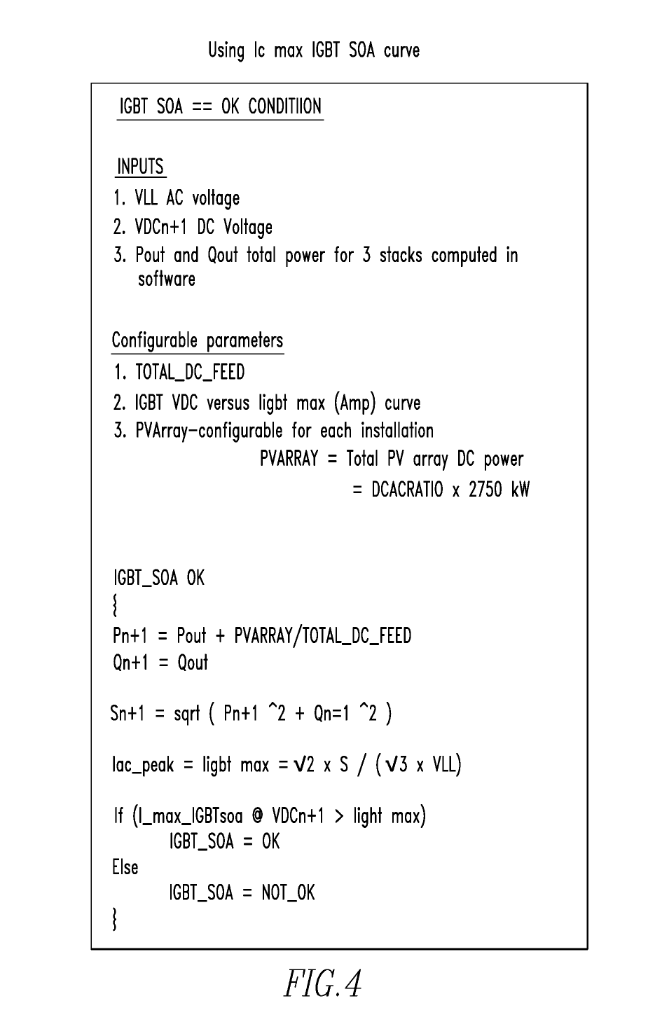

In a first particular exemplary embodiment, the IGBT SOA check of step 60 is performed as follows. First, controller 26 determines Pout and Qout, which are the total cumulative real power and total cumulative reactive power, respectively, for the three phases of inverter 10 based on measurements made by a number of sensing inputs (e.g., current and/or voltage input). Then, controller 26 computes Pn+1 (the total real output power after the newest feed is turned on), Qn+1 (the total reactive output power after the newest feed is turned on), and Sn+1 (the total apparent output power after the newest feed is turned on). The computed Sn+1 is then converted to current (amps), and the current is compared to a predetermined IGBT SOA current threshold (if at or below threshold, OK; if above threshold, NOT OK). An example computer algorithm for implementing this embodiment is shown in FIG. 4.

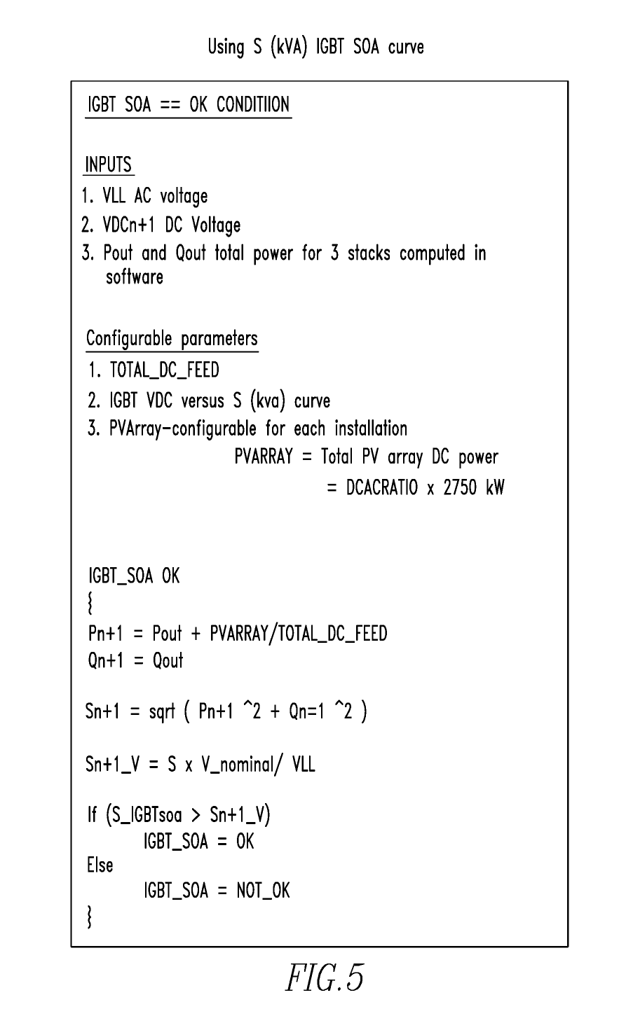

In a second particular exemplary embodiment, the IGBT SOA check is performed in a similar manner, expect that the IGBT SOA threshold is in terms of apparent power (kVA) rather than current. Thus, in this embodiment, the computed Sn+1 is compared to a predetermined IGBT SOA apparent power threshold (if at or below threshold, OK; if above threshold, NOT OK). An example computer algorithm for implementing this embodiment is shown in FIG. 5.

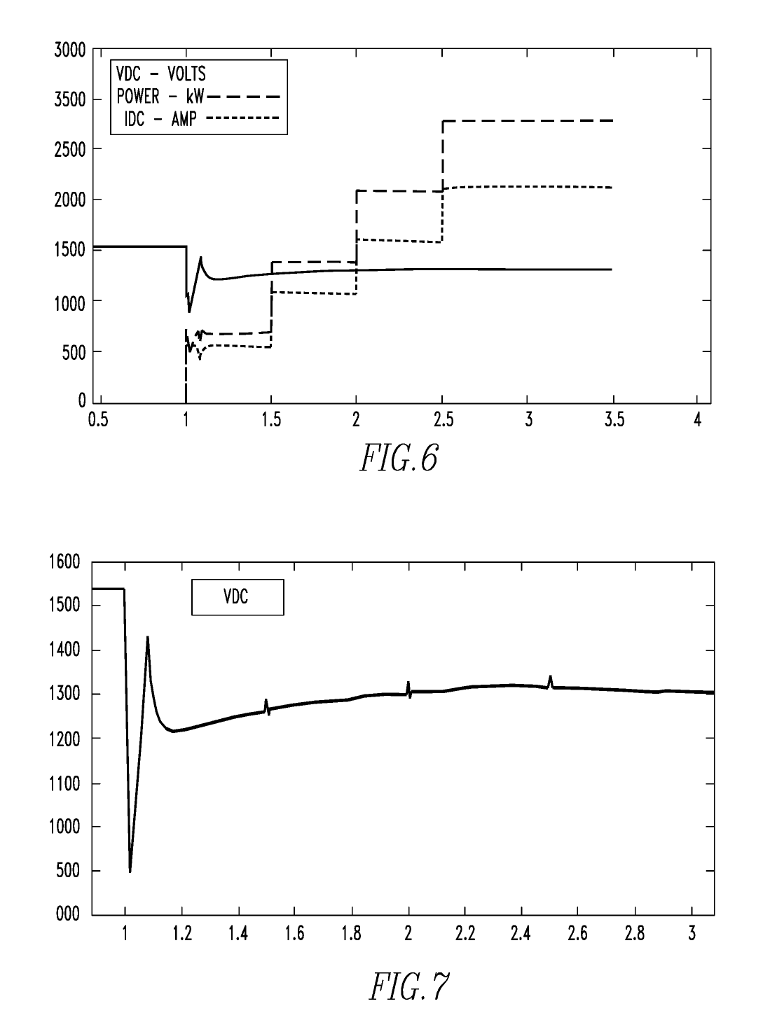

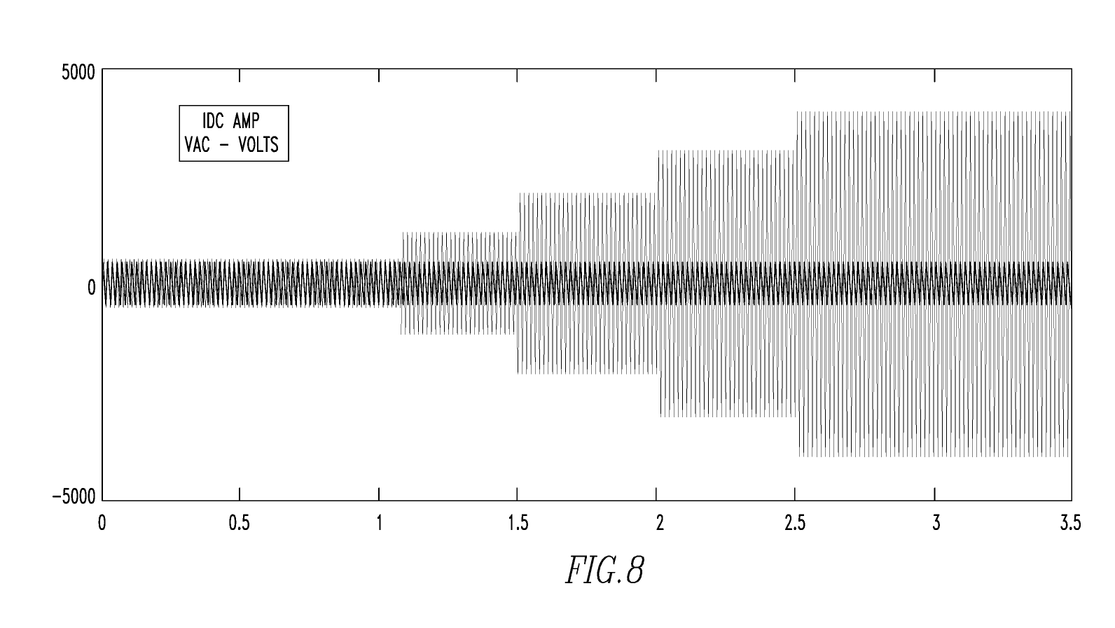

FIG. 6 graph of voltage versus time for a simulated startup sequence according to the disclosed concept. At t=0 seconds, DC feed #1 is connected to DC link 14 so that DC link 14 can be charged to 1500 VDC. At t=1.0 seconds, the gating signals are sent to inverter 10 and MPPT is enabled as described herein. At t=1.5 seconds, DC feed #2 is connected to DC link 14. At t=2.0 seconds, DC feed #3 is connected to DC link 14. At t=2.5 seconds, DC feed #4 is connected to DC link 14. FIG. 7 is a graph that shows the DC voltage on DC link 14 as each DC feed 8 is fed-in. As seen, there is a very small jump in DC bus voltage that would not cause issues for operation within typical SOAs. FIG. 8 is a graph that shows the output current of inverter 10 and the grid voltage as each DC feed 8 is fed-in.

The disclosed concept thus provides a multiple DC feed architecture wherein each DC feed is connected to the inverter DC link sequentially through a DC contactor. Each DC feed contactor is closed with a time delay that is based on logic that ensures that the inverter operation stays within the SOA of the inverter switching devices and that also ensures that the required power ramp rate is satisfied.

All of the disclosed concept has been described herein for exemplary purposes in connection with a photovoltaic power system, it will be understood that the disclosed concept may be practiced in other types of power systems that include inverters.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof

What is claimed is:

1. A method of starting a power system including an inverter having a plurality of DC feeds, the DC feeds including a first DC feed and a number of additional DC feeds, the method comprising:
connecting the first DC feed to a DC link of the inverter;
synchronizing the inverter to an AC grid;
connecting the synchronized inverter to the AC grid; and
for each of the additional DC feeds, responsive to determining: (i) that a predetermined time period based on a required power ramp rate of the inverter has elapsed, and (ii) that current operating conditions of the inverter are within a safe operating area of a plurality of switching devices of the inverter, connecting the additional DC feed to the DC link.

2. The method according to claim 1, wherein the determining that the current operating conditions of the inverter are within the safe operating area comprises determining a current (Ampere) value based on an output of the inverter and comparing the current (Ampere) value to a safe operating area current (Ampere) threshold.

3. The method according to claim 2, wherein the power system is a three phase system and wherein the current value is a total cumulative current value for all three phases of the three phase system.

4. The method according to claim 1, wherein the determining that the current operating conditions of the inverter are within the safe operating area comprises determining an apparent power value based on an output of the inverter and comparing the apparent power value to a safe operating area apparent power threshold.

5. The method according to claim 4, wherein the power system is a three phase system and wherein the apparent power value is a total cumulative apparent power value for all three phases of the three phase system.

6. The method according to claim 1, wherein the connecting the first DC feed to the DC link comprises turning on a first DC contactor provided in the first DC feed, and wherein the connecting each additional DC feed to the DC link comprises turning on an additional DC contactor provided in the additional DC feed.

7. The method according to claim 1, wherein the power system is a photovoltaic system and wherein the inverter is a photovoltaic inverter.

8. The method according to claim 1, wherein each of the switching devices is an IGBT.

9. A computer program product including a non-transitory computer readable medium encoded with a computer program comprising program code for implementing the method of claim 1.

10. A power system, comprising:
an inverter having a plurality of DC feeds, the DC feeds including a first DC feed and a number of additional DC feeds, a DC link, and a plurality of switching devices; and
a controller structured and configured to:
connect the first DC feed to the DC link;
synchronize the inverter to an AC grid;
connect the synchronized inverter to the AC grid; and
for each of the additional DC feeds, responsive to determining: (i) that a predetermined time period based on a required power ramp rate of the inverter has elapsed, and (ii) that current operating conditions of the inverter are within a safe operating area of the plurality of switching devices, connect the additional DC feed to the DC link.

11. The power system according to claim 10, wherein the controller is structured and configured to determine that the current operating conditions of the inverter are within the safe operating area by determining a current value based on an output of the inverter and comparing the current value to a safe operating area current threshold.

12. The power system according to claim 11, wherein the power system is a three phase system and wherein the current value is a total cumulative current value for all three phases of the three phase system.

13. The power system according to claim 10, wherein the controller is structured and configured to determine that the current operating conditions of the inverter are within the safe operating area by determining an apparent power value based on an output of the inverter and comparing the apparent power value to a safe operating area apparent power threshold.

14. The power system according to claim 13, wherein the power system is a three phase system and wherein the apparent power value is a total cumulative apparent power value for all three phases of the three phase system.

15. The power system according to claim 1, further comprising a first DC contactor provided in the first DC feed and an additional DC contactor provided in each additional DC feed, wherein the first DC feed is connected to the DC link by turning on the first DC contactor, and wherein each additional DC feed is connected to the DC link by turning on the additional DC contactor provided in the additional DC feed.

16. The power system according to claim 10, wherein the power system is a photovoltaic system and wherein the inverter is a photovoltaic inverter.

17. The power system according to claim 10, wherein each of the switching devices is an IGBT.
